(19) United States
(12) Patent Application Publication
(10) Pub. No.: US 2008/0319972 A1
(43) Pub. Date: Dec. 25, 2008

(54) SHORT PERIOD SEARCH KEYWORD

(76) Inventors: Rhonda L. Childress, Austin, TX (US); Janani Janakiraman, Austin, TX (US); David B. Kumhyr, Austin, TX (US)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(21) Appl. No.: 11/764,895

(22) Filed: Jun. 19, 2007

(51) Int. Cl. G06F 17/30

(52) U.S. Cl. 707/5; 707/E17.001

(57) ABSTRACT

A search engine provides a registration of short period search terms to provide memorable key words that allow a person to view a specific Web page without having to remember a long and complicated uniform resource locator. A search engine is modified to weight a specific search term to the highest value for a short period of time. A content provider may pay a price to have a memorable search term registered for a period of time. When the search engine receives a search request with the registered search term, the particular page will be placed on top of the search results due to the increased weight.

### BACKGROUND

1. Technical Field

The present application relates generally to an improved data processing system and method. More specifically, the present application is directed to a search engine with short period search keywords.

2. Description of Related Art

Internet search engines use indexes to display search results to users. The results displayed to a requesting user often include a great deal of irrelevant information depending on the scope of the search request. As the size of the Internet, and the amount of content on the World Wide Web, continues to grow, it becomes increasingly difficult to narrow a search to the desired subject matter. Content providers may even manipulate the content of a site so that their content appears in the results of more searches. This has become common practice, making performing a narrow-scoped search even more difficult.

Some Web pages that may be of particular interest to a subset of users are often buried within a Web site. This may result in a long and complicated uniform resource locator (URL). For example, a person may see a poster for an event such as a conference. The poster may include a long and complicated URL to get more information about the time and place for the event. As another example, a person may hear an advertisement on the radio with a specific promotional offer. The advertisement may direct listeners to go to a specific Web page to receive the promotional offer. These URLs are difficult to remember due to their length and complexity.

A person faced with the task of remembering a long URL may attempt to write down the complicated URL, which is subject to human error. Alternatively, the person may attempt to remember enough keywords to perform a search later on. However, as discussed above, performing a search for a particular page often results in millions of matching pages, or “hits,” many of which are completely irrelevant.

### SUMMARY

The illustrative embodiments recognize the disadvantages of the prior art and provide a registration of short period search terms to provide memorable key words that allow a person to view a specific Web page without having to remember a long and complicated uniform resource locator. A search engine is modified to weight a specific search term to the highest value for a short period of time. A content provider may pay a price to have a memorable search term registered for a period of time. When the search engine receives a search request with the registered search term, the particular page will be placed on top of the search results due to the increased weight.

In one illustrative embodiment, a method for short period keyword search comprises receiving a search request from a client, searching an index for matching entries satisfying the search request, forming a search response comprising the matching entries, identifying at least one matching entry having an associated short period keyword that matches a keyword in the search request, giving the at least one matching entry having an associated short period keyword that matches a keyword in the search request a highest weight in the search response, and returning the search response to the client.

In one exemplary embodiment, at least one entry in the search index comprises a short term keyword field. Identifying at least one matching entry comprises comparing each keyword in the search request with the short term keyword field. In a further exemplary embodiment, the at least one entry in the search index further comprises an expiration. Identifying at least one matching entry comprises determining whether the short period keyword is expired. In a still further exemplary embodiment, the at least one entry in the search index comprises a priority. Giving the at least one matching entry a highest weight in the search response comprises ranking the at least one matching entry in the search response based on priority.

In another exemplary embodiment, identifying at least one matching entry comprises searching a short period keywords index. At least one entry in the short period keywords index comprises a short term keyword field. In a further exemplary embodiment, the at least one entry in the short period keywords index further comprises an expiration. Identifying at least one matching entry comprises determining whether the short period keyword is expired. In a still further exemplary embodiment, the at least one entry in the short period keywords index comprises a priority. Giving the at least one matching entry a highest weight in the search response comprises ranking the at least one matching entry in the search response based on priority.

In yet another exemplary embodiment, the method further comprises publicizing a short period keyword on a promotional article. In a further exemplary embodiment, the promotional article is one of a poster, a magazine, a newspaper advertisement, a television advertisement, or a radio advertisement.

In another illustrative embodiment, a data processing system comprises a processor and a memory coupled to the processor. The memory comprises instructions which, when executed by the processor, cause the processor to receive a search request from a client search an index for matching entries satisfying the search request form a search response comprising the matching entries, identify at least one matching entry having an associated short period keyword that matches a keyword in the search request, give the at least one matching entry having an associated short period keyword that matches a keyword in the search request a highest weight in the search response, and return the search response to the client.

In further exemplary embodiments, the memory may contain instructions which, when executed by the processor, cause the processor to perform one or more of the operations described above with regard to the method.

In yet another illustrative embodiment, a computer program product comprises a computer useable medium having a computer readable program. The computer readable program, when executed on a computing device, causes the computing device to receive a search request from a client, search an index for matching entries satisfying the search request, form a search response comprising the matching entries, identify at least one matching entry having an associated short period keyword that matches a keyword in the search request, give the at least one matching entry having an associated short period keyword that matches a keyword in the search request a highest weight in the search response, and return the search response to the client.

In further exemplary embodiments, the computer readable program, when executed by the computing device, causes the computing device to perform one or more of the operations described above with regard to the method.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an exemplary distributed data processing system in which aspects of the illustrative embodiments may be implemented;

FIG. 2 is a block diagram of an exemplary data processing system in which aspects of the illustrative embodiments may be implemented;

FIG. 3 depicts an example of a promotional article with a long uniform resource locator in accordance with an illustrative embodiment;

FIG. 4 depicts an example of a promotional article with a short period search keyword in accordance with an illustrative embodiment;

FIG. 5 is a block diagram illustrating a search service with short period search keywords in accordance with an illustrative embodiment;

FIG. 6 illustrates an entry within the search index with a short term keyword in accordance with an illustrative embodiment;

FIGS. 7A and 7B illustrate an entry within the search index and an entry in a short term keywords index in accordance with an illustrative embodiment; and

FIG. 8 is a flowchart illustrating operation of a search engine with short term search keywords in accordance with an illustrative embodiment.

### DETAILED DESCRIPTION OF THE ILLUSTRATIVE EMBODIMENTS

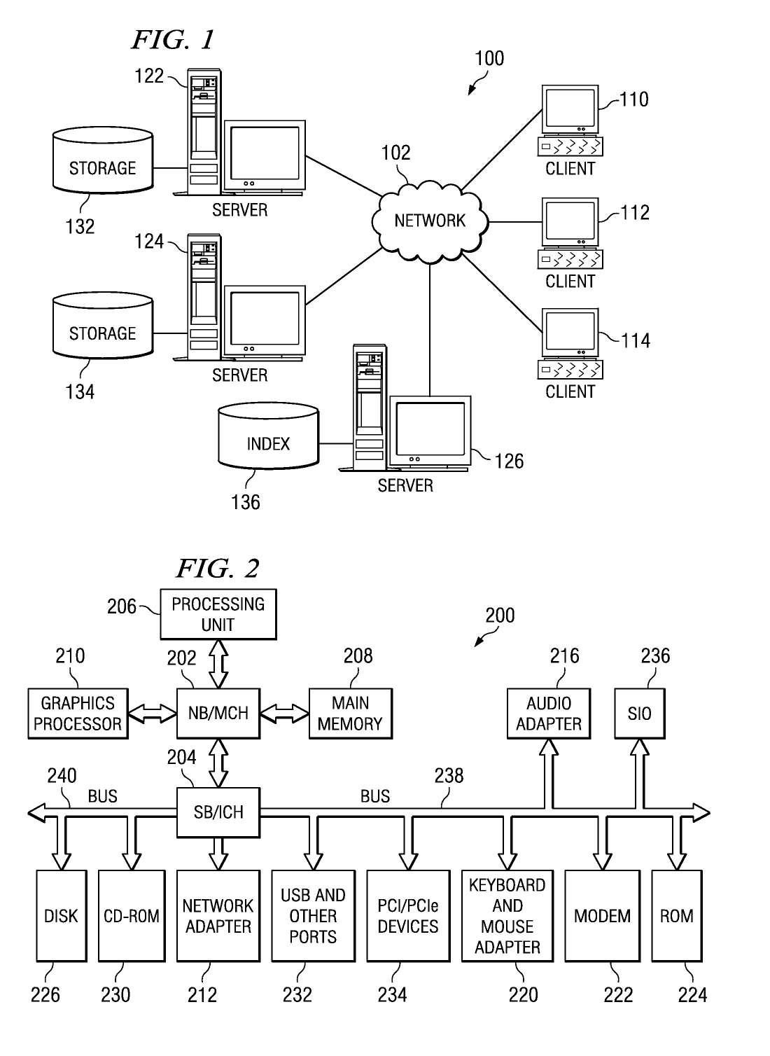

With reference now to the figures and in particular with reference to FIGS. 1 and 2, exemplary diagrams of data processing environments are provided in which embodiments of the present invention may be implemented. It should be appreciated that FIGS. 1 and 2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an exemplary distributed data processing system in which aspects of the illustrative embodiments may be implemented. Distributed data processing system 100 may include a network of computers in which embodiments of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 122 and server 124 are connected to network 102 and provide access to storage unit 132 and storage unit 134, respectively. In addition, clients 110, 112, and 114 are also connected to network 102. These clients 110, 112, and 114 may be, for example, personal computers, network computers, or the like. In the depicted example, servers 122 and 124, for example, provide data, such as Web pages, multimedia content, and applications, to the clients 110, 112, and 114. Clients 110, 112, and 114 are clients to servers 122 and 124 in the depicted example. Distributed data processing system 100 may include additional servers, clients, and other devices not shown.

Server 126 may provide a search engine for clients 110, 112, and 114. Clients 110, 112, 114 may submit a search request to a search engine on server 126, which then uses index 136 to generate a results page. To provide the most up-to-date results, server 126 accesses servers 122 and 124, or more particularly the content in storage units 132 and 134, to update search index 136.

As the size of the Internet, and the amount of content on the World Wide Web, continues to grow, it becomes increasingly difficult to narrow a search to the desired subject matter. Some Web pages that may be of particular interest to a subset of users who are often buried within a Web site. This may result in a long and complicated uniform resource locator (URL). In accordance with an illustrative embodiment, a search engine is modified to weight a specific search term to the highest value for a short period of time.

A search client may run on one of clients 110, 112, 114. The requested indexes are automatically refreshed and integrated with the main server-side indexes during a search. A content provider may pay a price to have a memorable search term registered for a period of time. When the search engine, at server 126, for example, receives a search request with the registered search term, the particular page will be placed on top of the search results due to the increased weight.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

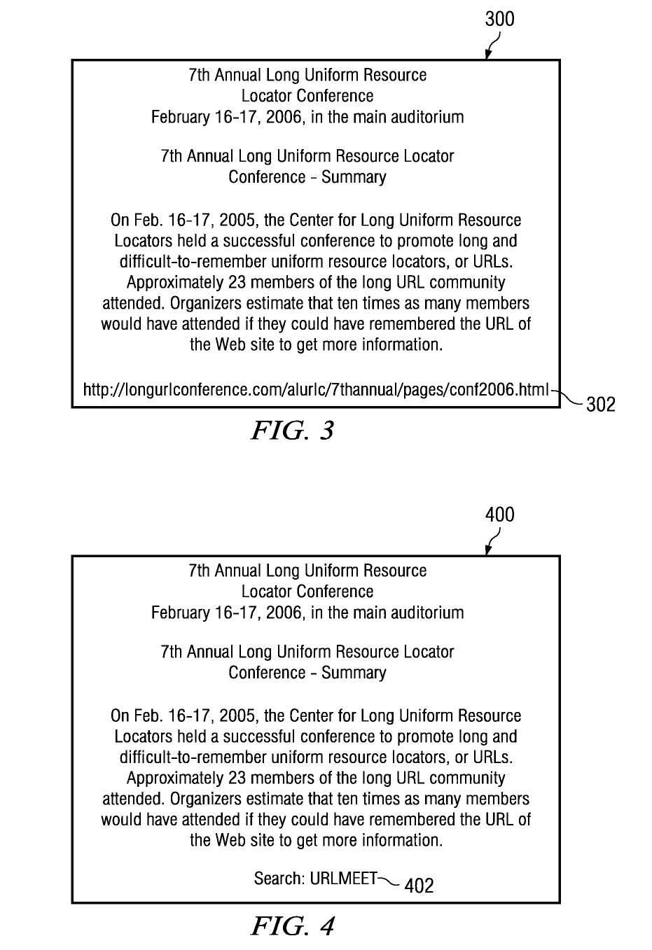

FIG. 3 depicts an example of a promotional article with a long uniform resource locator in accordance with an illustrative embodiment. Promotional article 300 may be, for example, a poster for a technology conference. Article 300 includes a uniform resource locator (URL) 302, which directs a viewer to a specific Web page for more information about the conference that is being promoted by the article. Alternatively, article 300 may be a magazine or newspaper advertisement, for instance. The parties responsible for promoting the conference could also promote the event using a television or radio advertisement, where URL 302 would be shown on screen or spoken.

As can be seen in FIG. 3, if a viewer were interested in the conference and wanted more information about the conference being promoted by article 300, the viewer would have to remember URL 302 to direct his or her Web browser to the appropriate Web page. Failing that, the viewer would have to remember keywords in article 300 to fashion a suitable search query to find the appropriate information. Most Internet users will recognize, however, that directing and narrowing a Web search to a particular page can be very difficult.

FIG. 4 depicts an example of a promotional article with a short period search keyword in accordance with an illustrative embodiment. Promotional article 400 may be, for example, a poster for a technology conference as in FIG. 3. However, promotional article 400 includes short period search keyword 402. The party responsible for promoting the event may obtain short period search keyword 402 from one or more search engines to provide a brief, easy-to-remember keyword that viewers can enter into a Web search engine to be directed to the appropriate information page.

According to a business model, the Web search engine provider may receive payment for the short period keyword, and provide a service for giving a particular Web page a higher weight in search results, thus placing a particular Web page at the top of the search results. In exchange for the payment, the Web search engine provider may provide the keyword for a limited amount of time. For instance, the party responsible for promoting the conference in FIG. 4 may purchase the keyword “URLMEET” only until the time of the conference. Thus, short period search keywords may have associated expiration dates.

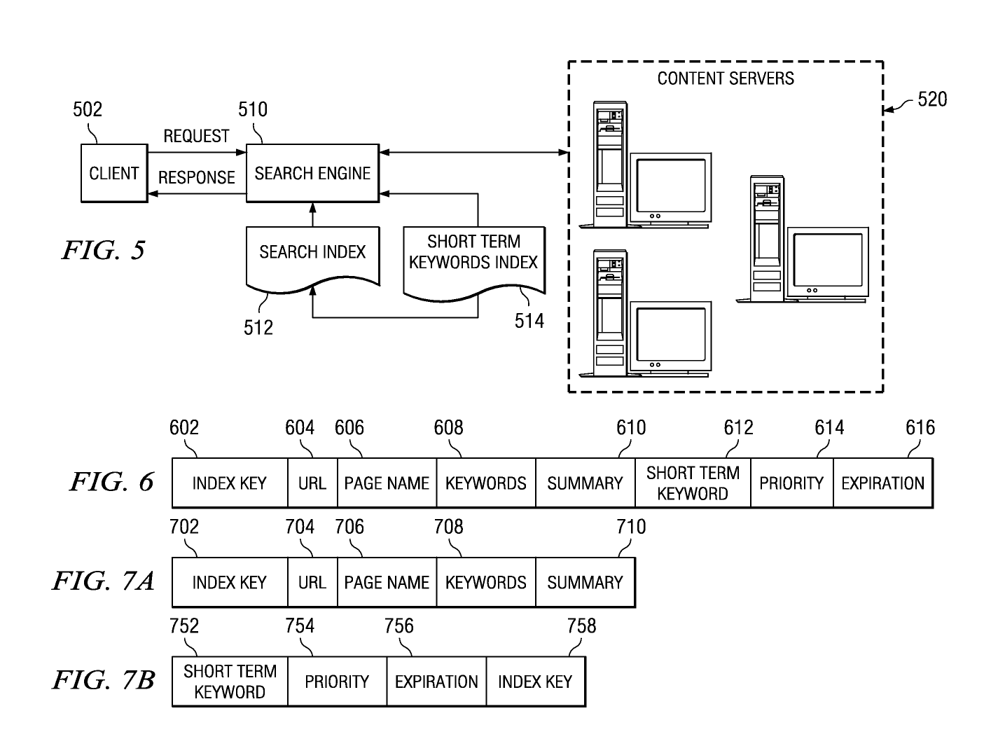

FIG. 5 is a block diagram illustrating a search service with short period search keywords in accordance with an illustrative embodiment. A user at client 502 submits a search request to search engine 510. Search engine 510 maintains search index 512 by receiving profiles from content servers 520, or by “crawling” through the Web pages provided by content servers 520. Search engine 510 builds and updates search index 512, adding new pages, adjusting weights for certain content, removing dead links, and so forth, as is conventional in the art.

According to one illustrative embodiment, search engine 510 stores short term keywords in association with index entries within search index 512. If a request from client 502 contains a short term keyword, search engine 510 locates the entry, or entries if there is more than one short term keyword in the request, within search index 512 and give that entry the highest weight. Thus, when search engine 510 returns the search response to client 502, the Web page associated with the short term keyword is placed on top of the results page.

In an alternative embodiment, search engine 510 maintains short term keywords index 514, which associates keywords with entries in search index 512. If a request from client 502 contains a short term keyword, search engine 510 locates the entry, or entries if there is more than one short term keyword in the request, within short term keywords index 514. The entry in short term keywords index 514 points to an entry in search index 512 by uniform resource locator (URL), index key, or the like. Search engine 510 then gives the highest weight to the entry in search index 512 pointed to by the matching entry in short term keywords index 514. Thus, when search engine 510 returns the search response to client 502, the Web page associated with the short term keyword is placed on top of the results page.

FIG. 6 illustrates an entry within the search index with a short term keyword in accordance with an illustrative embodiment. In the depicted example, the search index entry includes an index key 602. This index key 602 may be a unique identifier for the search index entry. The entry also includes the URL 604 of the page being indexed. This may be the long and complicated URL that a user may have difficulty remembering in the examples described above. The entry also includes keywords 608 that are associated with the page. The entry may also include summary text 610 that is presented within search results in association with the page name 606 and URL 604.

In accordance with the illustrative embodiment, the search index entry also includes short term keyword 612. The short term keyword 612 is a brief, memorable keyword that a user can enter into a search engine to be directed to a particular Web page that otherwise may have a very long and complicated URL. Short term keyword 612 may also be associated with priority 614 and expiration time/date 616. In one business model, a search engine may apply various levels to keywords by applying a priority. Thus, if one company purchases a short term keyword for a common word, such as “HOTEL,” another company can purchase a higher priority entry with the same short term keyword. Expiration time/date 616 stores the date and time that short term keyword 612 expires. While some content providers may provide static content and, thus, may always want their content associated with a particular keyword, those content providers will likely associate that content with their base domain name. Content providers with temporary pages, such as a page for a conference or a limited-time promotion for a new product, will purchase a short term keyword until a particular date.

FIGS. 7A and 7B illustrate an entry within the search index and an entry in a short term keywords index in accordance with an illustrative embodiment. More particularly, FIG. 7A illustrates an entry within the search index. In the depicted example, the search index entry includes an index key 702. This index key 702 may be a unique identifier for the search index entry. The entry also includes the URL 704 of the page being indexed. This may be the long and complicated URL that a user may have difficulty remembering in the examples described above. The entry also includes keywords 708 that are associated with the page. The entry may also include summary text 710 that is presented within search results in association with the page name 706 and URL 704.

In accordance with the illustrative embodiment, the short term keywords index entry, as shown in FIG. 7B, includes short term keyword 752. Short term keyword 752 is a brief, memorable keyword that a user can enter into a search engine to be directed to a particular Web page that otherwise may have a very long and complicated URL. Short term keyword 752 may also be associated with priority 754 and expiration time/date 756. Expiration time/date 756 stores the date and time that the short term keyword 752 expires. The short term keywords index entry also includes index key 758, which points to an entry in the search index, such as the entry shown in FIG. 7A, for example.

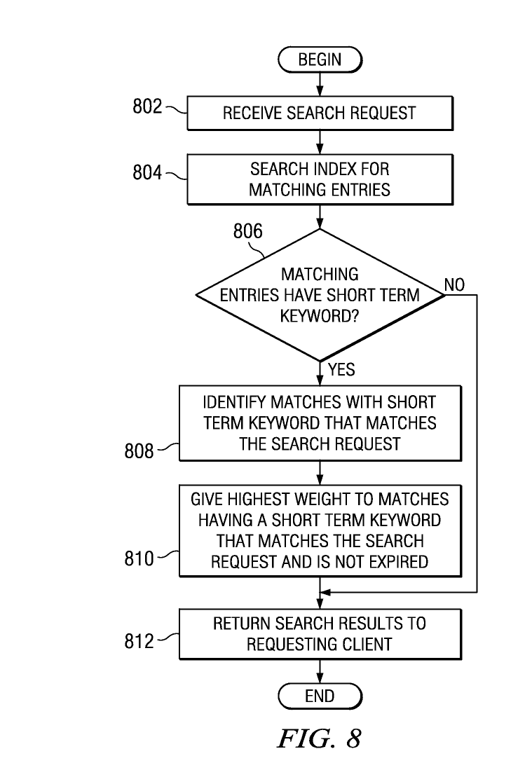

FIG. 8 is a flowchart illustrating operation of a search engine with short term search keywords in accordance with an illustrative embodiment. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

Furthermore, the flowchart is provided to demonstrate the operations performed within the illustrative embodiments. The flowchart is not meant to state or imply limitations with regard to the specific operations or, more particularly, the order of the operations. The operations of the flowchart may be modified to suit a particular implementation without departing from the spirit and scope of the present invention.

With reference now to FIG. 8, operation begins and the search engine receives a search request (block 802). The search engine searches the search index for matching entries (block 804). Next, the search engine determines whether any matching entries have a short term keyword (block 806). If any matching entries have a short term keyword, the search engine identifies matches with a short term keyword that matches a keyword in the search request (block 808). The search engine then gives the highest weight to matches having a short term keyword that matches the search request and is not expired (block 810). Thereafter, or if the search engine determines that there are no matching entries having a short term keyword in block 806, the search engine returns the search results to the requesting client (block 812). Then, operation ends.

Thus, the illustrative embodiments solve the disadvantages of the prior art by providing a registration of short period search terms to provide memorable key words that allow a person to view a specific Web page without having to remember a long and complicated uniform resource locator. A search engine is modified to weight a specific search term to the highest value for a short period of time. A content provider may pay a price to have a memorable search term registered for a period of time. When the search engine receives a search request with the registered search term, the particular page will be placed on top of the search results due to the increased weight.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read-only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for short period keyword search, the method comprising:
receiving a search request from a client;
searching an index for matching entries satisfying the search request;
forming a search response comprising the matching entries;
identifying at least one matching entry having an associated short period keyword that matches a keyword in the search request;
giving the at least one matching entry having an associated short period keyword that matches a keyword in the search request a highest weight in the search response; and
returning the search response to the client.

2. The method of claim 1, wherein at least one entry in the search index comprises a short term keyword field, wherein identifying at least one matching entry comprises comparing each keyword in the search request with the short term keyword field.

3. The method of claim 2, wherein the at least one entry in the search index further comprises an expiration, wherein identifying at least one matching entry comprises determining whether the short period keyword is expired.

4. The method of claim 2, wherein the at least one entry in the search index comprises a priority, wherein giving the at least one matching entry a highest weight in the search response comprises ranking the at least one matching entry in the search response based on priority.

5. The method of claim 1, wherein identifying at least one matching entry comprises searching a short period keywords index, wherein at least one entry in the short period keywords index comprises a short term keyword field.

6. The method of claim 5, wherein the at least one entry in the short period keywords index further comprises an expiration, wherein identifying at least one matching entry comprises determining whether the short period keyword is expired.

7. The method of claim 5, wherein the at least one entry in the short period keywords index comprises a priority, wherein giving the at least one matching entry a highest weight in the search response comprises ranking the at least one matching entry in the search response based on priority.

8. The method of claim 1, further comprising publicizing a short period keyword on a promotional article.

9. The method of claim 8, wherein the promotional article is one of a poster, a magazine, a newspaper advertisement, a television advertisement, or a radio advertisement.

10. A data processing system, comprising:
a processor; and
a memory coupled to the processor, the memory comprising instructions which, when executed by the processor, cause the processor to:
receive a search request from a client;
search an index for matching entries satisfying the search request;
form a search response comprising the matching entries;
identify at least one matching entry having an associated short period keyword that matches a keyword in the search request;
give the at least one matching entry having an associated short period keyword that matches a keyword in the search request a highest weight in the search response; and
return the search response to the client.

11. The data processing system of claim 10, wherein at least one entry in the search index comprises a short term keyword field, wherein identifying at least one matching entry comprises comparing each keyword in the search request with the short term keyword field.

12. The data processing system of claim 11, wherein the at least one entry in the search index further comprises an expiration, wherein identifying at least one matching entry comprises determining whether the short period keyword is expired.

13. The data processing system of claim 10, wherein identifying at least one matching entry comprises searching a short period keywords index, wherein at least one entry in the short period keywords index comprises a short term keyword field.

14. The data processing system of claim 13, wherein the at least one entry in the short period keywords index further comprises an expiration, wherein identifying at least one matching entry comprises determining whether the short period keyword is expired.

15. A computer program product comprising a computer useable medium having a computer readable program, wherein the computer readable program, when executed on a computing device, causes the computing device to:
receive a search request from a client;
search an index for matching entries satisfying the search request;
form a search response comprising the matching entries;
identify at least one matching entry having an associated short period keyword that matches a keyword in the search request;
give the at least one matching entry having an associated short period keyword that matches a keyword in the search request a highest weight in the search response; and
return the search response to the client.

16. The computer program product of claim 15, wherein at least one entry in the search index comprises a short term keyword field, wherein identifying at least one matching entry comprises comparing each keyword in the search request with the short term keyword field.

17. The computer program product of claim 16, wherein the at least one entry in the search index further comprises an expiration, wherein identifying at least one matching entry comprises determining whether the short period keyword is expired.

18. The computer program product of claim 16, wherein the at least one entry in the search index comprises a priority, wherein giving the at least one matching entry a highest weight in the search response comprises ranking the at least one matching entry in the search response based on priority.

19. The computer program product of claim 15, wherein identifying at least one matching entry comprises searching a short period keywords index, wherein at least one entry in the short period keywords index comprises a short term keyword field.

20. The computer program product of claim 19, wherein the at least one entry in the short period keywords index further comprises an expiration, wherein identifying at least one matching entry comprises determining whether the short period keyword is expired.
